(19) United States
(12) Patent Application Publication
(10) Pub. No.: US 2014/0244858 A1
(43) Pub. Date: Aug. 28, 2014

(54) COMMUNICATION SYSTEM AND RELAYING DEVICE

(71) Applicant: Panasonic Corporation, Osaka (JP)

(72) Inventor: Yoshinori OKAZAKI, Osaka (JP)

(73) Assignee: Panasonic Corporation, Osaka (JP)

(21) Appl. No.: 14/190,668

(22) Filed: Feb. 26, 2014

Related U.S. Application Data
(63) Continuation of application No. PCT/JP2013/001337, filed on Mar. 4, 2013.

(30) Foreign Application Priority Data
Mar. 5, 2012 (JP) 2012-047629

(51) Int. Cl. H04L 29/06

(52) U.S. Cl. CPC H04L 65/605; H04L 65/608
USPC 709/231

(57) ABSTRACT

The relaying device includes a first receiving unit configured to receive at least one streaming video data from at least one sending device, a second receiving unit configured to receive, from one of at least one receiving device, information about a screen configuration of the one receiving device and information for designating a streaming video data to be sent to the one receiving device, a converting unit configured to dynamically convert at least one designated streaming video data among a plurality of pieces of streaming video data being received from a plurality of sending devices, into streaming video data with lower data volume so that the at least one designated streaming video data fits in the screen, and a sending unit configured to send the converted streaming video data to the one receiving device.

### BACKGROUND

1. Technical Field

The present disclosure relates to a communication system including devices which communicate video data therebetween and a relaying device which relays video data communicated between the devices.

2. Related Art

There is known a service for distributing video data to user terminals over a network. For example, JP 2007-110586 A discloses a video distribution system which extracts data according to a request by a user terminal from composite video data including synthesized plural pieces of video source data and sends the extracted data.

According to the video distribution system of JP 2007-110586 A, a multi-encoder receives video data of one video source which is a video source intended by a user and video data of other video sources, converts them into the MPEG4 format, and synthesizes them into a composite video data. Then, the video distribution system sends the data to a video distribution server. The video distribution server extracts the video data of the video source from the received composite video data by checking an ID number and sends the video data to the user terminal.

### SUMMARY

With the recent improvement of communication speed and display resolution of display terminals, distribution of higher quality video sources is desired.

In a system which collects a plurality of video sources in a server to be distributed, as the number of video sources increases, communication data volume increases. Particularly in the case where higher quality video data is sent, an increase of the data volume is more significant. When the communication band of the network is insufficient for the data volume to be communicated, the network cannot perform a smooth communicating operation.

The present disclosure provides a communication system and a communication device which can dynamically process video data to enable the video data to be sent properly depending on a situation.

The communication system according to the present disclosure includes at least one sending device, at least one receiving device, and a relaying device for relaying data sent from the sending device to the receiving device. The relaying device includes a first receiving unit configured to receive at least one streaming video data from the at least one sending device, a second receiving unit configured to receive, from one of the at least one receiving device, information about a screen configuration of the one receiving device and information for designating streaming video data to be sent to the one receiving device, a converting unit configured to dynamically convert at least the one designated streaming video data among a plurality of pieces of streaming video data being received from a plurality of sending devices, into streaming video data with lower data volume so that the at least one designated streaming video data fits in the received screen configuration of the one receiving device, and a sending unit configured to send the converted streaming video data to the one receiving device.

The relaying device according to the present disclosure is a relaying device for relaying data sent from at least one sending device, to at least one receiving device. The relaying device includes a first receiving unit configured to receive at least one streaming video data from the at least one sending device, a second receiving unit configured to receive, from one of the at least one receiving device, information about a screen configuration of the one receiving device and information for designating a streaming video data to be sent to the one receiving device, a converting unit configured to dynamically convert at least one designated streaming video data among a plurality of pieces of streaming video data being received from a plurality of sending devices, into streaming video data with lower data volume so that the at least one designated streaming video data fits in the screen, and a sending unit configured to send the converted streaming video data to the one receiving device.

According to the present disclosure, a communication system and a relaying device which can properly send a video depending the situation, particularly, which can reduce a communication load in a situation in which a plurality of streaming videos are simultaneously distributed can be provided.

### BRIEF DESCRIPTION OF DRAWINGS

FIG. 1 is a communication system block diagram of digital cameras 100, smart phones 250, and a server 300.

FIG. 2 is an electric block diagram of the digital camera 100.

FIG. 3 is an electric block diagram of the smart phone 250.

FIG. 4 is an electric block diagram of the server 300.

FIG. 5 is a sequence diagram about connecting operations between the digital cameras 100, the smart phone 250, and the server 300.

FIGS. 6A-6D represent an image chart illustrating examples of images distributed from the server 300 to the smart phone 250.

FIGS. 7A-7C are flow charts illustrating image processing operations in the server 300.

FIG. 8 is a sequence diagram about a disconnecting operation between the digital camera 100, the smart phone 250, and the server 300, and

FIG. 9 is a sequence diagram of a remote control for the digital camera 100 by the smart phone 250 via the server 300.

### DETAILED DESCRIPTION OF PREFERRED EMBODIMENTS

Embodiments will be described below in detail with reference to the drawings as required. However, unnecessarily detailed description may be omitted. For example, detailed description of already known matters and redundant description of substantially the same configuration may be omitted. All of such omissions are for avoiding unnecessary redundancy in the following description to facilitate understanding by those skilled in the art.

The inventor(s) provide the attached drawings and the following description for those skilled in the art to fully understand the present disclosure and do not intend to limit the subject matter described in the claims to the attached drawings and the following description.

### First Embodiment

The configuration and operation of a communication system according to the first embodiment will be described.

### 1-1. Configuration

The configuration of the communication system according to the present disclosure will be described below with reference to the drawings.

### 1-1-1. Configuration of Communication System

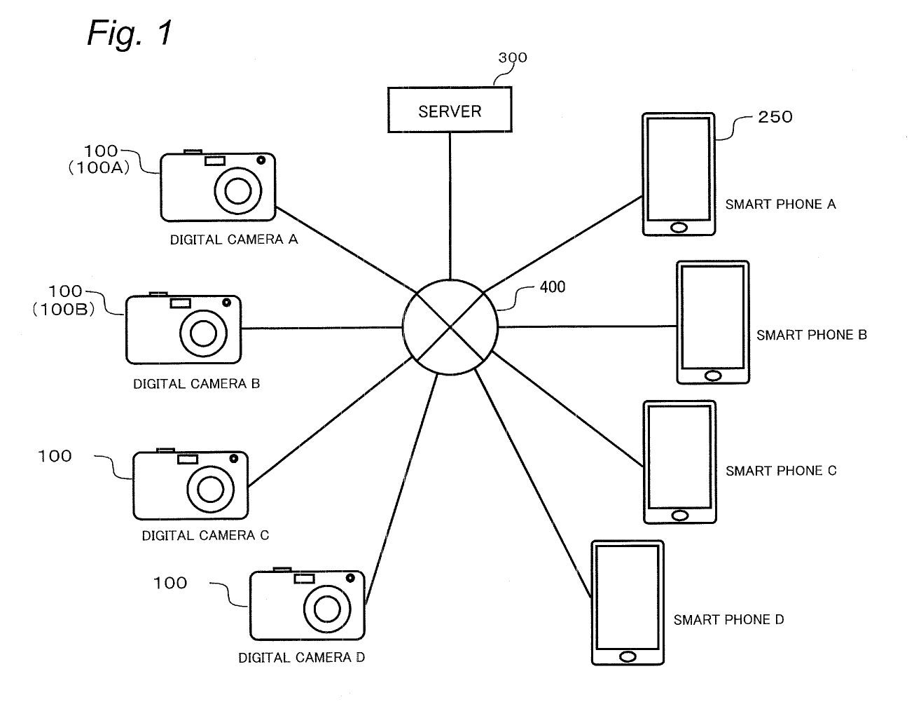

FIG. 1 is a diagram illustrating a configuration of the communication system according to the present disclosure. The communication system includes digital cameras 100, smart phones 250, and a server 300.

FIG. 1 illustrates a configuration in which the plurality of digital cameras 100A, 100B, 100C, 100D and the plurality of smart phones 250 (A, B, C, D, . . . ) are connected to the server 300 over a network 400.

Each digital camera 100 (A, B, C, D, . . . ) can send a stream of a currently captured through image (or a higher quality moving image) to the server 300. That is, each digital camera 100 (A, B, C, D, . . . ) can send a real-time video data to the server 300.

On the other hand, each smart phone 250 (A, B, C, D, . . . ) can receive a stream of a through image (or a higher quality moving image) which is sent from each digital camera 100 (A, B, C, D, . . . ) to the server 300. That is, from the server 300, each smart phone 250 (A, B, C, D, . . . ) can receive a real-time video data which is sent from each digital camera 100 (A, B, C, D, . . . ) to the server 300.

The server 300 receives the streaming video data which is being sent from each digital camera 100 (A, B, C, D, . . . ) and sends the pieces of received streaming video data to each smart phone 250 (A, B, C, D, . . . ) specified by each digital camera 100 (A, B, C, D, . . . ). On this occasion, in the case where the server 300 receives requests to send a plurality of pieces of streaming video data from the plurality of digital cameras 100 (A, B, C, D, . . . ) to a single smart phone 250, the server 300 dynamically converts the plurality of pieces of streaming video data into streaming video data with lower data volume (with lower occupancy band).

As described above, with the communication system according to the first embodiment, video data can be dynamically sent so that the video data can be properly sent depending on the situation.

Although the digital camera 100 is taken as an example of the sending device for streaming video data in the first embodiment, the sending device is not limited to that. That is, any device may be used for the sending device as long as the device can send streaming video data to the server 300, such as a digital movie camera, a monitoring camera, an onboard camera, and a camera-equipped information terminal (such as a smart phone).

Further, although the smart phone 250 is taken as an example of the receiving device for streaming video data in the first embodiment, the receiving device is not limited to that. That is, any device may be used for the receiving device as long as the device can receive streaming video data from the server 300 and display the streaming video, such as a tablet terminal, a television receiver, and a digital camera equipped with a display monitor.

Further, in the first embodiment, the server 300 is taken as an example of a relaying device for the streaming video data. However, the relaying device is not limited to that. That is, any device may be used for the relaying device as long as the device can receive at least one piece of streaming video data from at least one sending device, perform predetermined conversion on the received streaming video data, and send the streaming video data to the receiving device.

Hereinafter, in the present embodiment, a digital camera is taken as an example of a sending device for the streaming video data, a smart phone is taken as an example of the receiving device for the streaming video data, and a server is taken as an example of a relaying device.

### 1-1-2. Configuration of Digital Camera

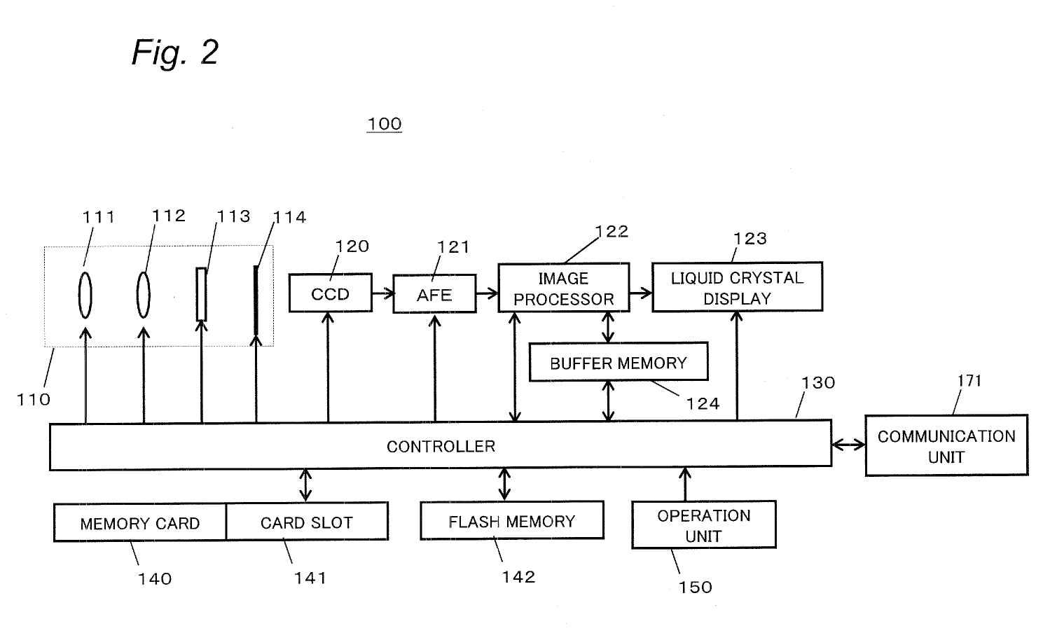

FIG. 2 is an electric block diagram of the digital camera 100. The digital camera 100 captures a subject image formed via an optical system 110 by a CCD image sensor 120. The CCD image sensor 120 generates image data based on the captured subject image. The image data generated by image capturing is subject to various types of processing in an AFE (Analog Front End) 121 and an image processor 122. The generated image data is recorded in a flash memory 142 or a memory card 140. The image data recorded in the flash memory 142 or the memory card 140 is displayed on a liquid crystal display 123 in response to an operation of an operation unit 150 by a user.

The optical system 110 includes a focus lens 111, a zoom lens 112, a diaphragm 113, and a shutter 114. Although not shown, the optical system 110 may include an optical image stabilizer lens OIS. The respective lenses included in the optical system 110 may include any number of lenses or any number of lens groups.

The CCD image sensor 120 captures a subject image formed via the optical system 110 and generates image data. The CCD image sensor 120 generates a new frame of image data at a predetermined frame rate (for example, 30 frames/second). The timing of image data generation by the CCD image sensor 120 and an electronic shutter operation are controlled by the controller 130. With the image data successively displayed on the liquid crystal display 123 as a through image, the user can confirm the situation of the subject on the liquid crystal display 123 in real time.

The AFE 121 performs noise suppression by correlated double sampling, multiplication of gain based on an ISO sensitivity value by an analog gain controller, and A/D conversion by an A/D converter on the image data read from the CCD image sensor 120. Then, the AFE 121 outputs the image data to the image processor 122.

The image processor 122 performs various types of processing on the image data output from the AFE 121. The various types of processing include, but not limited to, BM (block memory) accumulation, smear correction, white balance correction, gamma correction, YC conversion process, electronic zoom process, compression, and expansion. The image processor 122 may be made of a hardwired electronic circuit, a microcomputer using programs, or the like. The image processor 122 may also be made into a single semiconductor chip together with the controller 130 and the like.

The liquid crystal display 123 is provided on the rear of the digital camera 100. The liquid crystal display 123 displays an image based on the image data processed by the image processor 122. The liquid crystal display 123 displays the images such as a through image and a recorded image.

The controller 130 performs integrated control over the operations of the entire digital camera 100. The controller 130 may be made of a hardwired electronic circuit, may be made of a microcomputer, or the like. The controller 130 may also be made into a single semiconductor chip together with the image processor 122 and the like.

The flash memory 142 functions as an internal memory for recording the image data and the like. The flash memory 142 also stores programs related to autofocus control (AF control) and communication control as well as programs for performing integrated control over the operations of the entire digital camera 100.

The buffer memory 124 is a storing section that functions as a work memory for the image processor 122 and the controller 130. The buffer memory 124 can be implemented by a DRAM (Dynamic Random Access Memory) or the like.

The card slot 141 is a connecting section that allows the memory card 140 to be attached and detached. The card slot 141 can be electrically and mechanically connected to the memory card 140. The card slot 141 may also be provided with a function for controlling the memory card 140.

The memory card 140 is an external memory that contains a recording unit such as the flash memory. The memory card 140 can record data such as the image data to be processed in the image processor 122.

The communication unit 171 is a wireless or wired communication interface and the controller 130 can be connected to an internet network via the communication unit 171. For example, the communication unit 171 can be implemented by a USB, Bluetooth (registered trademark), a wireless LAN, a wired LAN, or the like.

The operation unit 150 collectively refers to operation buttons and control levers provided on the exterior of the digital camera 100 for receiving an operation from the user. When receiving an operation from the user, the operation unit 150 sends various operation indication signals to the controller 130.

### 1-1-3. Configuration of Smart Phone

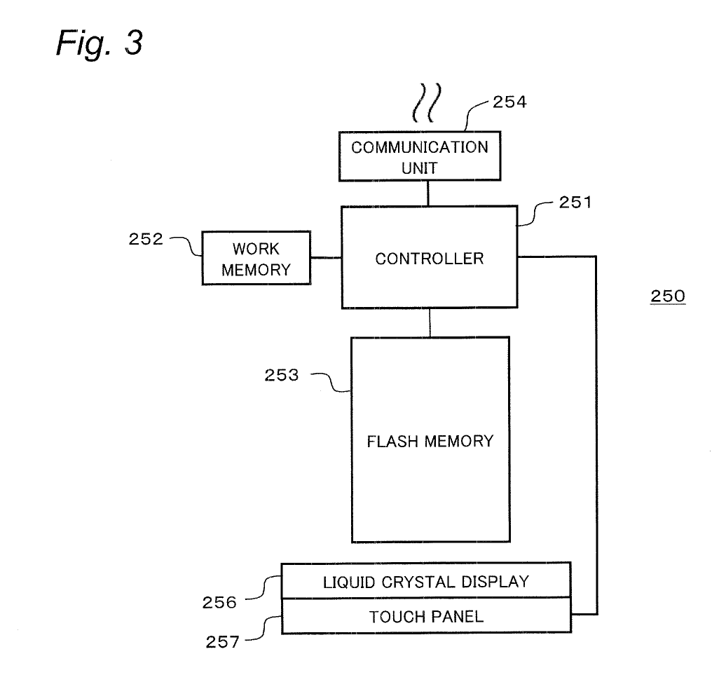

A configuration of the smart phone 250 will be described with reference to FIG. 3. FIG. 3 is an electric block diagram of the smart phone 250.

The smart phone 250 includes a controller 251, a work memory 252, a flash memory 253, a communication unit 254, a liquid crystal display 256, a touch panel 257, and the like. Although not shown in the figure, the smart phone 250 may include an image capturing unit and an image processor.

The controller 251 is a processor for performing processing on the smart phone 250. The controller 251 is electrically connected to the work memory 252, the flash memory 253, the communication unit 254, the liquid crystal display 256, and the touch panel 257. The controller 251 receives information about an operation from the user performed on the touch panel 257. The controller 251 can read data stored in the flash memory 253. The controller 251 also globally controls over the system including the power supplied to the respective components of the smart phone 250. Although not shown, the controller 251 performs telephone function and various applications downloaded over the Internet.

The work memory 252 is a memory for temporarily storing information necessary for the controller 251 to execute the respective processing operations.

The flash memory 253 is a disk drive with a large capacity for storing respective types of data. As described above, the respective types of data stored in the flash memory 253 can be read by the controller 251 as required. Although the smart phone 250 has the flash memory 253 in the present embodiment, the smart phone 250 may have a hard disk drive or the like instead of the flash memory.

The liquid crystal display 256 is a display device which displays a screen specified by the controller 251.

The touch panel 257 is an input device for receiving information about an operation from the user. Although the smart phone 250 has the touch panel 257 as the input device for receiving information about an operation from the user in the present embodiment, the smart phone 250 may have hard keys instead of the touch panel.

The communication unit 254 can send image data received from the controller 251 to other device(s) over the internet network. The communication unit 254 can be implemented by, for example, a wired LAN or a wireless LAN.

### 1-1-4. Configuration of Server

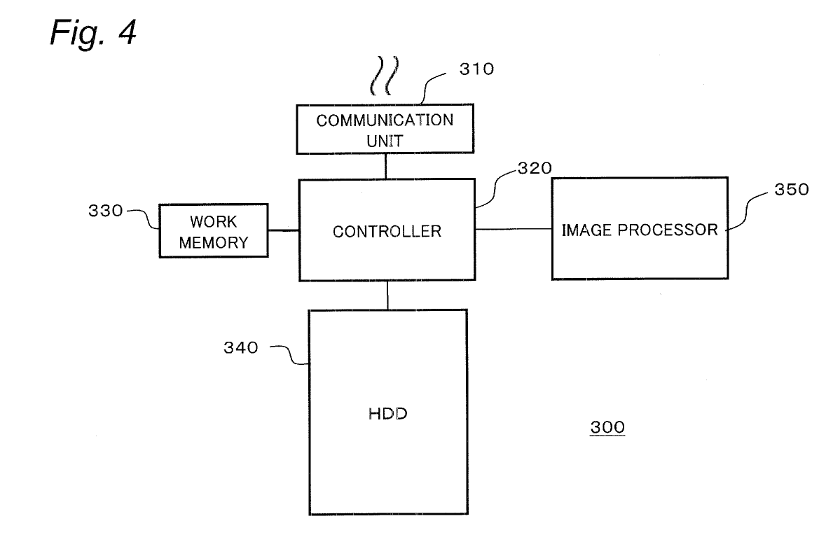

A configuration of the server 300 will be described with reference to FIG. 4. FIG. 4 is an electric block diagram of the server 300.

The server 300 includes a communication unit 310, a controller 320, a work memory 330, an HDD (hard disk drive) 340, an image processor 350, and the like.

The communication unit 310 can receive information from other device(s) (image information, request information, response information, and the like) and send the information to the other device(s), over the internet network. The communication unit 310 can be implemented by, for example, a wired LAN or a wireless LAN.

The controller 320 is a processor for performing processing on the server 300. The controller 320 is electrically connected to the communication unit 310, the work memory 330, the HDD 340, and the image processor 350. The controller 320 processes information (image information, request information, and the like) obtained via the communication unit 310. Also, based on the processing, the controller 320 sends the information (image information, response information, and the like) via the communication unit 310. The controller 320 uses the work memory 330, the HDD 340, and the image processor 350 to process the information as required. Further, the controller 210 can read data stored in the work memory 330 and the HDD 340. Also, the controller 210 globally controls over the system such as the power supplied to the respective components of the server 300.

The work memory 330 is a memory for temporarily storing information necessary for the controller 320 to execute the various processing operations.

The HDD 340 is a disk drive with a large capacity for storing various types of data. As described above, the various types of data stored in the HDD 340 can be read by the controller 320 as required. Although the present embodiment is provided with the HDD 340, the present embodiment may be provided with the other recording medium instead.

The image processor 350 performs various types of image processing on the input image information based on an instruction from the controller 320. The various types of image processing include a mixing process, a resizing process, a synthesizing process, and a coding process. The detailed operations of the image processing by the image processor 350 will be described later.

### 1-2. Operation

### 1-2-1. Connection Between Digital Cameras, Smart Phone, and Server

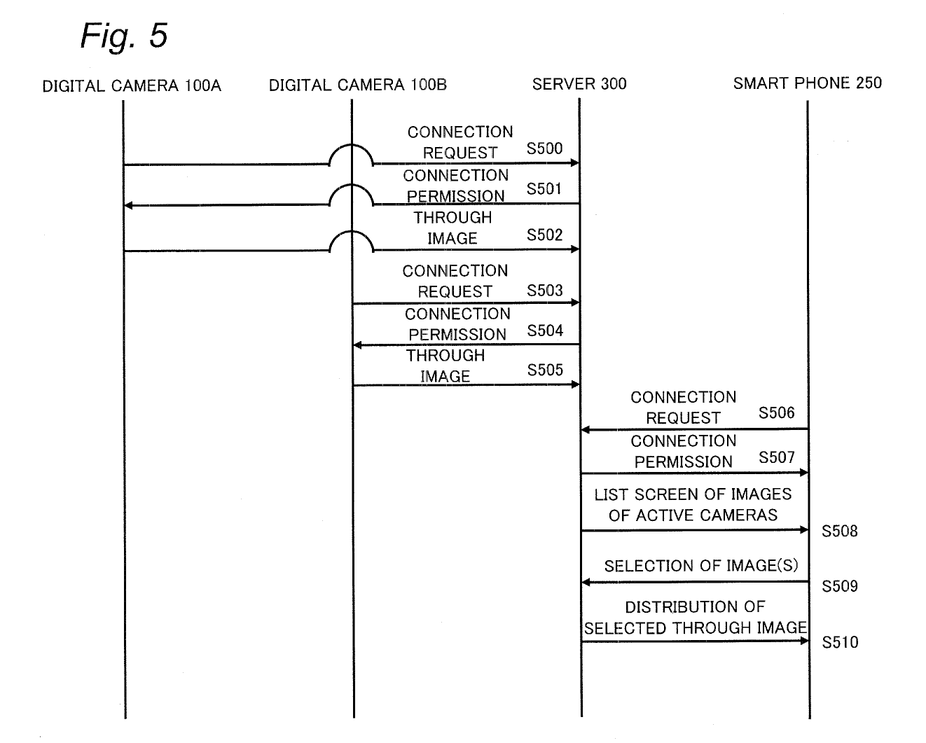

Connecting operations between the digital cameras 100, the smart phone 250, and the server 300 will be described with reference to FIG. 5. FIG. 5 is a sequence diagram about connecting operations between the digital cameras 100, the smart phone 250, and the server 300.

As described with reference to FIG. 1, the plurality of digital cameras 100 (A, B, C, D, . . . ) can be connected with the plurality of smart phones 250 (A, B, C, D, . . . ). However, for the simplicity of the description, the connecting operation will be described below by taking a case where the digital camera 100A and the digital camera 100B and the smart phone 250 are connected to the server 300 over the Internet 400 as an example.

First, the operations of the digital camera 100A will be described. When the digital camera 100A is switched ON, the controller 130 of the digital camera 100A supplies power to the respective components of the digital camera 100A and controls the digital camera 100A to be ready for shooting and communication.

When the digital camera 100A is ready for shooting and communication, the user can operate the operation unit 150 of the digital camera 100A to cause a menu screen to be displayed on the liquid crystal display 123. Then, the user can operate the operation unit 150 to select an item on the menu screen to instruct the start of communication. When the item for instructing the start of communication is selected by the user, the controller 130 searches for an access point to which the digital camera 100A can be connected. Then, the controller 130 connects to the access point found by the search to obtain the IP address. When completing the obtaining of the IP address, the digital camera 100A sends a connection request to the server 300 via the access point (S500).

When receiving the connection request from the digital camera 100A via the communication unit 310, the controller 320 of the server 300 determines whether the digital camera 100A is allowed to be connected with the server 300. When the connection of the digital camera 100A would not cause any trouble, such as in the case where a predetermined number or more of digital cameras are connected with the server 300 and accordingly the throughput of the server 300 decreases, the controller 320 of the server 300 notifies the controller 130 of the digital camera 100A via the communication unit 310, of a connection permission (S501). When receiving the connection permission, the controller 130 of the digital camera 100A sends a currently captured through image or a higher quality moving image for recording to the server 300 (controller 320) via the communication unit 171 (S502).

Next, the operations of the digital camera 100B will be described. As in the case of the above described digital camera 100A, the digital camera 100B performs the sending of the connection request (S503: corresponding to S500), the receiving of the connection permission (S504: corresponding to S501), the supplying of a through image or a higher quality moving image for recording (S505: corresponding to S502).

Next, the operations of the smart phone 250 will be described. When the smart phone 250 is switched ON, the controller 251 of the smart phone 250 supplies power to the respective components of the smart phone 250 and controls the smart phone 250 to be ready for communication.

When the smart phone 250 is ready for communication, the user can operate the touch panel 257 of smart phone 250 to cause a menu screen to be displayed on the liquid crystal display 256. Then, the user can operate the touch panel 257 to select an item on the menu screen to instruct the start of communication. When the item for instructing the start of communication is selected by the user, the controller 251 searches for an access point. The controller 251 connects to the access point found by the search to obtain the IP address. When completing the obtaining of the IP address, the smart phone 250 sends a connection request to the server 300 via the access point (S506).

When receiving the connection request from the smart phone 250 via the communication unit 310, the controller 320 of the server 300 determines whether the smart phone 250 is allowed to be connected with the server 300. When the connection of the smart phone 250 would not cause any trouble to the server 300, the controller 320 of the server 300 notifies the controller 251 of the smart phone 250 of a connection permission via the communication unit 310 (S507). The trouble which would occur in the server 300 is such that the server 300 is connected with a predetermined number or more of smart phones 250 and, accordingly, the throughput of the server 300 decreases.

Then, the controller 320 of the server 300 generates a list screen of images of currently active cameras based on video data sent from the respective digital cameras and sends the image information to the smart phone 250 (S508).

On the list screen, display frames for displaying the active camera images (through image and moving image) are arranged. Detailed examples of the list screen will be described later. The controller 320 of the server 300 generates a streaming video data for displaying active camera images (through image or higher quality moving image) sent from each digital camera in each display frame and sends the streaming video data to the smart phone 250. That is, the controller 320 of the server 300 reads the pieces of the through image data (or pieces of higher quality moving image data) which are sent from the respective digital cameras 100A and 100B and temporarily recorded in the HDD 340 by a predetermined data volume, generates a streaming video data from the read through images, and sends the streaming video data (sends a stream of video data) to the smart phone 250. As a result, the list screen is displayed on the liquid crystal display 256 of the smart phone 250 with the images of the active cameras (streaming video) sent from the digital cameras 100A and 100B being displayed in the display frames.

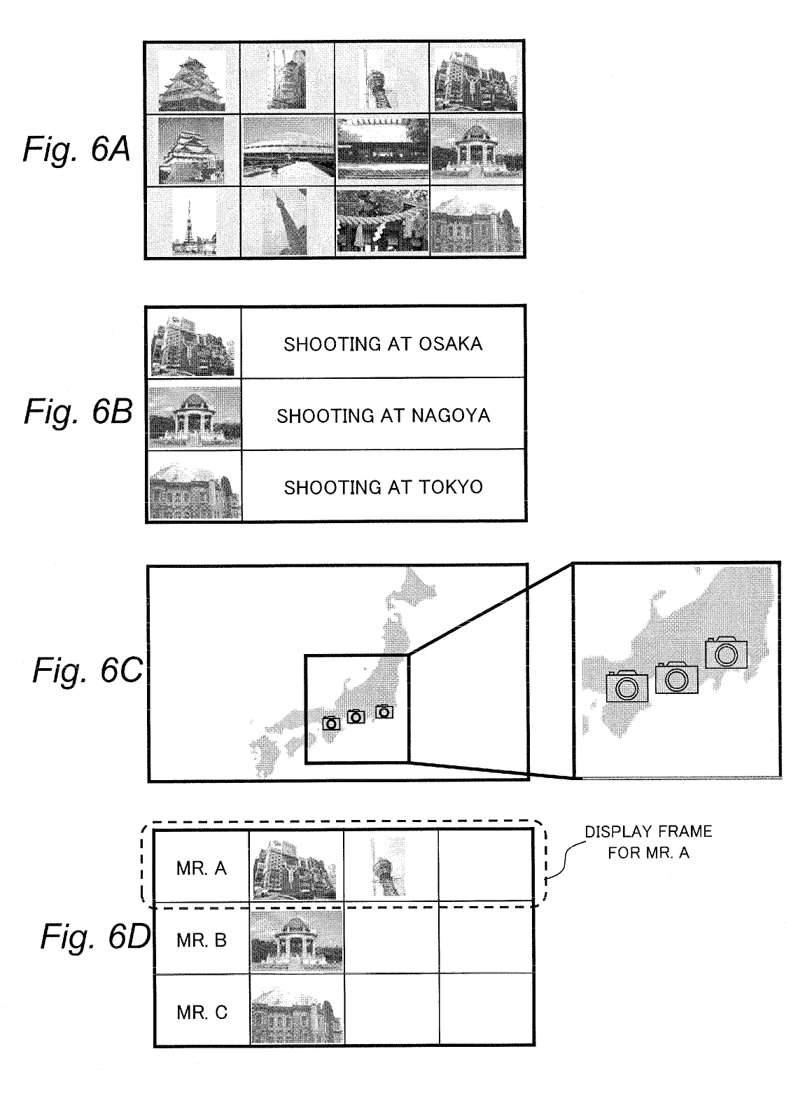

FIGS. 6A to 6D are diagrams illustrating examples of images distributed from the server 300 to the smart phone 250. That is, FIGS. 6A to 6D are diagrams illustrating examples of the list screen of active camera images displayed on the liquid crystal display 256 of the smart phone 250.

FIG. 6A is a diagram illustrating an example of the list screen in which real time streaming videos obtained from a plurality of cameras are arranged in, for example, the matrix of three columns and four rows in the server 300. That is, FIG. 6A illustrates the list screen in which real time streaming videos sent from 12 digital cameras 100 are displayed. With such a display, the user of the smart phone 250 can confirm a list of the real time streaming videos obtained from the server 300.

FIG. 6B illustrates an example of the list screen in which real time streaming videos obtained from a plurality of cameras are displayed with character information about the streaming videos. In the example illustrated in FIG. 6B, as the character information about the streaming videos, pieces of character information about shooting locations of the real time videos are displayed in combination with the streaming videos. The example illustrated in FIG. 6B can be implemented by the server 300 receiving the information about the pieces of the streaming video data together with the pieces of the streaming video data from the digital cameras 100. With such a screen as FIG. 6B, the user can easily confirm the information about the real time streaming video data obtained from the server 300. Although the information about the streaming video is described as character information about the shooting location of the real time video in this example, the information is not limited to that. That is, the character information may be substituted with pictographic information or the like. Further, imaging conditions, the time of day that the video is recorded (local time in the case where the video is recorded overseas), or the like may be used instead of the shooting location of the video.

FIG. 6C illustrates a screen showing locations on a map at which the streaming videos are being recorded with respect to the real time streaming videos obtained from a plurality of cameras. The example illustrated in FIG. 6C can be implemented by the server 300 receiving the information about the shooting locations of the streaming videos together with the pieces of the streaming video data from the cameras 100. As a result, the user can easily confirm the shooting locations of the pieces of the real time streaming video data obtained from the server 300.

FIG. 6D illustrates an example of the list screen in which real time streaming videos obtained from a plurality of cameras via the server 300 are displayed with information about photographers (names, pictures of the photographers' faces, and the like) of the streaming videos. The example illustrated in FIG. 6D can be implemented by the server 300 receiving the information about the photographers of the streaming videos together with the pieces of the streaming video data from the cameras 100. Note that, when a photographer is sending a plurality of the pieces of the streaming video data recorded by using a plurality of cameras in real time, the plurality of streaming videos are displayed side by side in a display frame which indicates the streaming videos are recorded by the photographer. As a result, the user can easily confirm the photographer of the pieces of the real time streaming video data obtained from the server 300.

The form of the list screens to be sent to the smart phone 250 out of the forms illustrated in FIGS. 6A to 6D may be decided according to a user operation. For example, the communication system may be configured to allow the user of the smart phone 250 to select an intended list screen by operating the operation unit such as the touch panel 257. In that case, the selection information of the list screen is sent from the smart phone 250 to the server 300 and, based on the selection information, the server 300 generates the list screen. As a result, the user can easily view the pieces of the real time streaming video data obtained from the server 300 in a preferred form.

The communication system may be configured to cause the server 300 to send the pieces of the streaming video data to the smart phone 250 in response to designation of the smart phone 250 by the respective digital cameras 100A and 100B which are the sources of the pieces of the video data. In that case, the digital cameras 100A and 100B send designation information to the server 300. The server 300 sends the respective pieces of the streaming video data received from the digital cameras 100A and 100B only to the smart phone 250 designed by the received designation information.

Alternatively, the digital cameras 100A and 100B which are the sources of the pieces of the video data may set range of publication of the pieces of the streaming video data to be sent to the server 300. In that case, the digital cameras 100A and 100B send information about the range of audience to the server 300. The server 300 may be configured to send the pieces of the streaming video data only to the smart phone 250 which matches the range of publication indicated by the received information. Although the server 300 is configured to send a real time streaming video data as video data to be contained in the list screen displayed on the liquid crystal display 256 of the smart phone 250 here, the object to be contained in the list screen is not limited to the video. The server 300 may use a still image cut out from a real time streaming video at a particular time, instead of the real time streaming video.

While viewing the list screen of images of the active cameras, the user selects a streaming video which the user wants to view in detail by operating the operation unit such as the touch panel 257 of the smart phone 250. On that occasion, the user can select a plurality of streaming videos which the user wants to view in detail. When the controller 251 of the smart phone 250 receives the selection of the streaming videos made by the user, the controller 251 notifies information (designation) about the selection by the user to the controller 320 of the server 300 via the communication unit 254 (S509).

In response to the notification of the information about the selection in step S509, the controller 320 of the server 300 performs image processing by the image processor 350 on the pieces of the streaming video data sent from the digital cameras 100A and 100B if required. Then, the controller 320 of the server 300 receives distribution of the streaming videos (through images or moving images) selected by the user of the smart phone 250 (S510). As a result, the user can easily enjoy viewing only the streaming videos the user selected.

### 1-2-2. Image Processing by Image Processor of Server

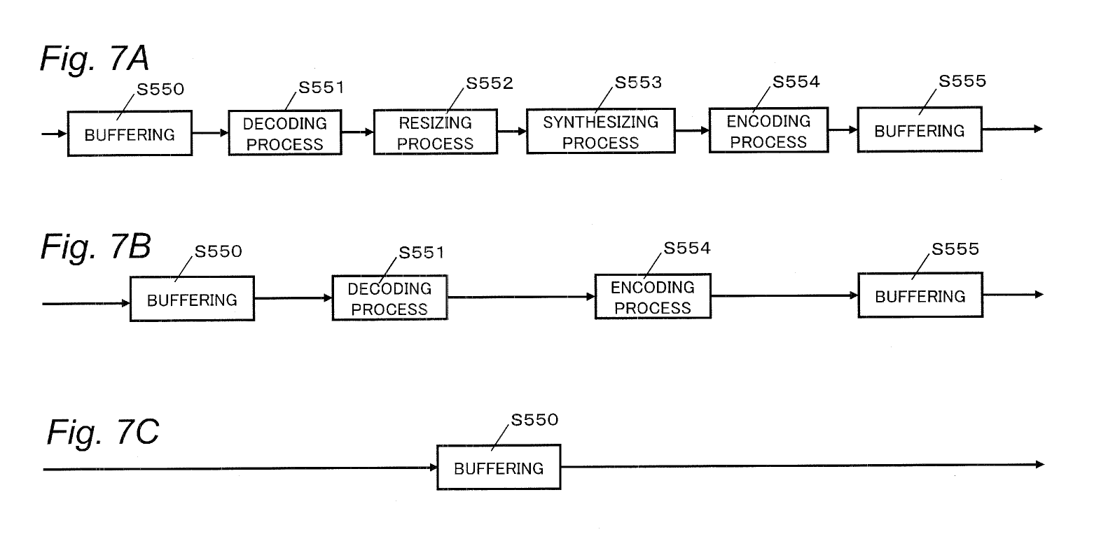

The image processing by the image processor 350 of the server 300 on the streaming video data will be described with reference to FIG. 7. The image processing by the image processor 350 on the streaming video to be distributed to the smart phone 250 will be described below.

### Image Processing Example 1

FIG. 7A is a diagram illustrating a sequence of an image processing operation in the server 300. FIG. 7A particularly describes an example in the case where the user selects distribution of the streaming videos from the digital cameras 100A and 100B.

When the controller 320 of the server 300 receives the pieces of the streaming video data from the digital cameras 100A and 100B, the controller 320 buffers (temporarily records in the HDD 340) the streaming video data received from the digital camera 100A (hereinafter, referred to as “streaming video A”) and the streaming video data received from the digital camera 100B (hereinafter, referred to as “streaming video B”) (S550). When sending the pieces of the streaming video data via the communication unit 171, the digital camera 100A and the digital camera 100B send the pieces of the through image data (or pieces of higher quality moving image data) which are compressed and encoded based on a predetermined compression encoding method to the server 300. That is, the buffered streaming video A and the streaming video B are information which is compressed and encoded based on a predetermined compression encoding method. Therefore, the image processor 350 performs a decoding process corresponding to the predetermined compression encoding method on the streaming video A and the streaming video B to convert the videos into information expanded as images (S551).

Subsequently, the image processor 350 performs the resizing process on the decoded streaming video A and streaming video B to make the videos available to be viewed on the same screen of the liquid crystal display 256 of the smart phone 250 (S552). For example, when the streaming video A is sized (has the pixel configuration of) QVGA and the streaming video B is also sized (has the pixel configuration of) QVGA, the image processor 350 performs the resizing process to make the images indicated by the streaming video A and the streaming video B sized available to be output to the same screen in QVGA. Here, the image processor 350 performs the resizing process on the respective streaming video A and streaming video B to reduce the sizes by 50% as an example.

Subsequently, the image processor 350 performs the synthesizing process on both of the resized streaming video A and streaming video B to make the images indicated by the respective streaming videos to be contained in the same screen in QVGA size (pixel configuration) (S553). Hereinafter, the video of the streaming video A and the streaming video B arranged in the same screen by the synthesizing process (S553) will be referred to as “synthesized streaming video”. The synthesized streaming video is a video including a screen illustrated in FIG. 6A, 6B, or 6D, for example.

Subsequently, the image processor 350 performs the compression and encoding processing according to the predetermined compression encoding method on the synthesized streaming video in QVGA size (S554). The synthesized streaming video which has been subject to the compression and encoding processing is buffered (temporarily recorded in the work memory 330) in order (S555). Then, the buffered synthesized streaming video is read in order and a stream of the video is distributed to the smart phone 250 via the communication unit 310.

Although the size (pixel configuration) for the resizing process performed by the image processor 350 is described as QVGA in the above example, the size is not limited to that. The size may be any other size (pixel configuration) as long as the size is suitable for the smart phone 250 which receives and displays the streaming video.

### Image Processing Example 2

FIG. 7B illustrates a sequence of the image processing in the case where only the streaming video data from one of the digital cameras 100 is distributed to the smart phone 250. FIG. 7B illustrates a processing example in the case where the compression encoding method performed on the streaming video data when the streaming video data is received from the digital camera 100 differs from the compression encoding method which can be decoded by the smart phone 250. In that case, the resizing process and the synthesizing process are not required. The image processor 350 performs the decoding process on the streaming video data being buffered in order (S551), then, performs the encoding process in the compression encoding method which can be decoded by the smart phone 250 (S554).

### Image Processing Example 3

FIG. 7C describes a sequence of the image processing in the case where only the streaming video data from one of the digital cameras 100 is distributed to the smart phone 250. FIG. 7C illustrates a processing example in the case where the compression encoding method performed on the streaming video data when the streaming video data is received from the digital camera 100 is the same as the compression encoding method which can be decoded by the smart phone 250. In that case, since the resizing process, the decoding process, and the encoding process are not required, the image processor 350 is buffering the streaming video data received from the digital camera 100 in order (S550) while distributing the video to the smart phone 250 via the communication unit 310.

As described above, the image processor 350 of the server 300 according to the present embodiment dynamically determines the image processing according to the conditions of the streaming video(s) received from the digital camera(s) such as the number, the size (pixel configuration), the compression encoding method, and the like of the streaming video and executes the processing. As a result, the server 300 can distribute a suitable streaming video(s) to the smart phone(s) 250 depending on the state of distribution of the streaming video(s) and the situation of the smart phone(s) 250.

1-2-3. Cut-Off Operation of Streaming Video Provided from Digital Camera

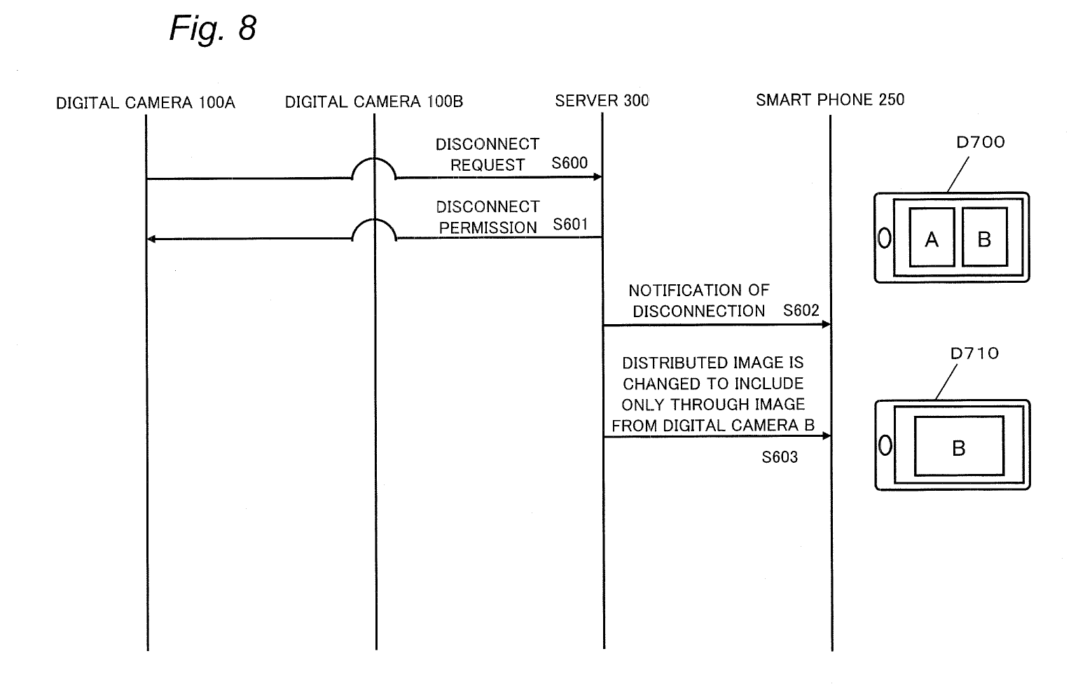

The case where sending of video to the server 300 is cut off will be described with reference to FIG. 8. The case where the digital camera 100A cuts off sending of video data to the server 300 when the digital cameras 100A and 100B are sending pieces of real time streaming video data to the server 300 will be described below. FIG. 8 is a sequence diagram of a disconnecting operation of the digital camera 100, the smart phone 250, and the server 300.

When the controller 130 of the digital camera 100A receives an operation made by the user on the operation unit 150 while sending a streaming video A from the digital camera 100A to the server 300, the controller 130 decides to cut off the sending of the streaming video A. The operation by the user here may be an operation to stop sending the video data or an operation to stop power supply to the digital camera 100A.

When the controller 130 of the digital camera 100A decides to cut off the sending of the streaming video A to the server 300, the controller 130 notifies a disconnect request to the server 300 via the communication unit 171 (S600). In response, the controller 320 of the server 300 notifies a disconnect permission to the digital camera 100A via the communication unit 310 (S601). In the case where the image processor 350 of the server 300 is receiving pieces of streaming video data from two digital cameras of the digital camera 100A and the digital camera 100B at this moment, the image processor 350 is in the processes of step S551 to step S554 in order as illustrated in FIG. 7A. However, once the disconnection is permitted in response to the disconnect request from the digital camera 100A, the streaming video B from the digital camera 100B is the only streaming video sent to the server 300. Therefore, after the reception of the streaming video A is cut off, the image processor 350 performs the processing illustrated in FIG. 7B or 7C in order.

Then, the controller 130 of the server 300 distributes only the through image from the digital camera 100B to the smart phone 250 via the communication unit 310 (S603).

In FIG. 8, the screen D700 shows an example of a display screen on the liquid crystal display 256 of when the synthesized streaming video resulting from synthesizing the stream video A and the stream video B is distributed to the smart phone 250 and displayed on the liquid crystal display 256. On the other hand, the screen D710 illustrated in FIG. 8 shows an example of a display screen on the liquid crystal display 256 of when the distribution of the streaming video A is cut off in the state of the screen D700 and only the streaming video B is being distributed.

As described above, with the server 300 according to the first embodiment, the display state of the liquid crystal display 256 of the smart phone 250 is changed according to the change in the distribution state (or cutting-off state) of the streaming video data from the digital camera 100 which is the source of the streaming video data. As a result, the user can be easily informed of the providing situation of the streaming video data.

### 1-2-4. Remote Control for Digital Camera by Smart Phone Via Server

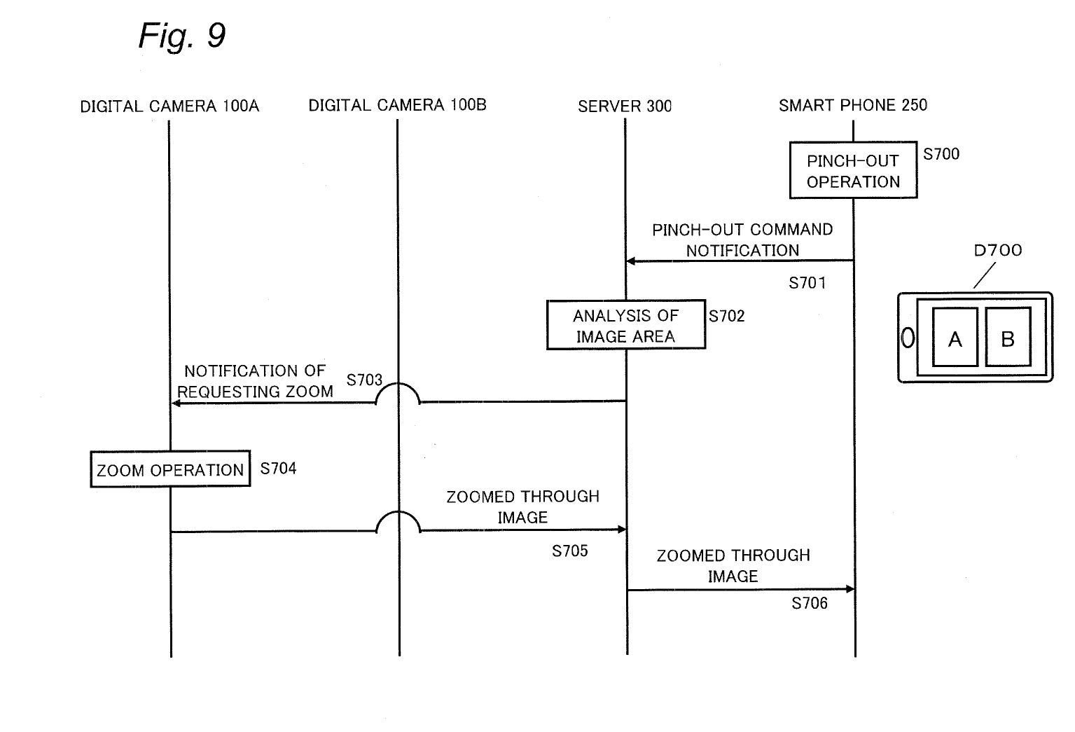

A remote control for the digital camera 100 by the smart phone 250 via the server 300 will be described with reference to FIG. 9. Particularly, the case where the smart phone 250 performs a remote control for the digital camera 100A based on an operation performed by the user with respect to the streaming video will be described below with reference to FIG. 9. FIG. 9 is a sequence diagram of a remote control for the digital camera 100 by the smart phone 250 via the server 300.

The smart phone 250 is receiving the streaming video A and the streaming video B from the digital cameras 100A and 100B via the server 300 (see the screen D700 of FIG. 9). The case where the user operates the touch panel 257 of the smart phone 250 in that situation to enable a zoom operation of the digital camera 100A will be described below.

The user can perform a pinch-out operation on the touch panel 257 of the smart phone 250 to enlarge an area for displaying the streaming video sent from the digital camera 100A. Here, the pinch-out operation is an operation corresponding to an operation of enlarging an image, i.e., an operation of zooming to the telephoto side. When the user performs the pinch-out operation (S700), the controller 251 of the smart phone 250 sends information about that a pinch-out operation is performed and about an image area (position on the touch panel 257) on which the pinch-out operation is performed to the server 300 as a pinch-out command notification via the communication unit 254 of the smart phone 250 (S701).

When the controller 320 of the server 300 receives the pinch-out command notification sent from the smart phone 250 via the communication unit 310, the controller 320 analyzes the image area on which the pinch-out operation is performed (S702).

When the controller 320 of the server 300 detects that the pinch-out operation (the zoom operation) is performed in the area within the streaming video sent from the digital camera 100A as a result of analysis, the controller 320 generates a notification of requesting a zoom to the telephoto side. Then, the controller 320 of the server 300 sends the generated notification of requesting a zoom to the digital camera 100A via the communication unit 310 (S703).

The controller 130 of the digital camera 100A receives the notification of requesting a zoom to the telephoto side sent from the server 300 via the communication unit 171 of the digital camera 100A. Based on the received notification of requesting a zoom, the controller 130 performs zooming to the telephoto side by controlling the optical system 110 (S704).

Then, the controller 130 sends the zoomed through image to the server 300 via the communication unit 171 (S705). On this occasion, it is preferable that the controller 130 sends the through image to the server 300 in real time in response to a practical zooming operation.

The controller 320 of the server 300 sends the zoomed through image received from the digital camera 100A to the smart phone 250 (S706). On this occasion, it is preferable that, after the controller 320 of the server 300 receives the through image from the digital camera 100, the controller 320 transfers the through image to the smart phone 250 without delay.

As a result, the smart phone 250 can operate the digital camera 100A at a distant based on an operation performed by the user with respect to the received streaming video. Also, the user of the smart phone 250 can obtain the through image reflecting the result of the remote control in real time.

### 1-3. Conclusion

The communication system according to the present embodiment includes at least one digital camera 100 (an example of the sending device), at least one smart phone 250 (an example of the receiving device), and a server 300 (an example of the relaying device) for relaying data sent from the digital camera 100 to the smart phone 250. The server 300 receives at least one streaming video data from the at least one digital camera 100 via a communication unit 310. The server 300 receives from one of the at least one smart phone 250, information about a screen configuration of the one smart phone 250 (selection of an image, specification of an image, operation information, and the like) and information for designating streaming video data to be sent to the one smart phone 250 via the communication unit 310. A controller 320 of the server 300 dynamically converts at least one designated streaming video data among a plurality of pieces of streaming video data being received from a plurality of digital cameras 100, into streaming video data with lower data volume (lower occupancy band) so that the at least one designated streaming video data fits in the screen. The server 300 sends the converted streaming video data to the one smart phone 250 via the communication unit 310. As a result, a communication system which reduces a communication load even when a plurality of streaming videos are distributed simultaneously can be provided.

Further, the controller 320 may dynamically change the conversion processing performed on the streaming video data according to the sending state (the number, the image size, the compression encoding method, and the like of the streaming video to be sent) of the streaming video data from the digital camera 100 (transmitter). As a result, the video data can be properly sent according to the sending state of the streaming video data from the digital camera 100 (transmitter).

The controller 320 may perform the conversion processing to contain a plurality of pieces of streaming video data in one piece of video streaming data.

Further, the smart phone 250 may perform a remote control on the digital camera 100 via the server 300 with respect to the processing on the streaming video data. As a result, a remote control from the smart phone 250 is enabled to the streaming video data sent from the digital camera. Specifically, the server 300 may receive information about an operation by the user on one of the smart phones 250 from the smart phone 250, analyze content of the information, and based on the analysis result (for example, the operated area), control a situation of the streaming video received from the digital camera 100. Alternatively, the server 300 may receive information about an operation by the user on one of the smart phones 250 from the smart phone 250, and send a designation about processing of the streaming video data based on the received information about the operation to the digital camera 100.

### Other Embodiments

As described above, the first embodiment is described as an example of the arts disclosed in the present application. However, the arts in the present disclosure are not limited to that embodiment and may also be applied to embodiments which is subject to modification, substitution, addition, or omission as required. Also, the respective components described in the first embodiment may be combined to form a new embodiment. Then, other embodiments will be exemplified below.

In the above described first embodiment, the streaming video A and the streaming video B are subject to the resizing process and synthesized into a single streaming video having both of the streaming videos arranged in the same screen. The method for converting a plurality of pieces of streaming video data into a single piece of streaming video data is not limited to that. For example, the image processor 350 of the server 300 may change the compression ratio in the encoding processing on the streaming video to be distributed to the smart phone 250 according to the number of streaming video(s) to be provided. More specifically, the image processor 350 may increase the compression ratio in the encoding processing when many pieces of streaming video data are provided, and may decrease the compression ratio when a few pieces of streaming video data are provided. That is, any other method may be used as long as the method converts a plurality of pieces of streaming video data to reduce the band required for communication of the converted data.

Although the zoom operation is taken as an example of the remote control by using the smart phone 250 in the above described embodiment, the remote control is not limited to the zoom operation. The remote control by using the smart phone 250 may be an operation of switching images by a shutter operation or a pan-tilt operation.

For example, when the user performs a touch operation on the touch panel 257 of the smart phone 250 which is displaying a plurality of streaming videos, the smart phone 250 may select only the touched video for display. Specifically, when the user performs a touch operation on the smart phone 250 which is displaying a plurality of streaming videos, the smart phone 250 may send the operation information to the server 300. That is, the smart phone 250 may send information indicating the touched position on the touch panel 257, on which the user performs a touch operation, to the server 300 as a command notification. Based on the position information included in the received command notification, the server 300 analyzes the area operated by the user. Then, the server 300 may determine that a video related to the area operated by the user is “selected”, and generate a piece of streaming video data to be sent to the smart phone 250 so that only the selected video is displayed.

In the above described embodiment, when the server 300 receives the pinch-out command notification from the smart phone 250 (S701), the server 300 analyzes the area operated by the user (S702) and sends the notification of requesting a zoom to the digital camera (S703). Alternatively, the controller 320 of the server 300 may analyze the area operated by the user and electronically enlarge the video in the operated area (electronic zoom) instead of sending the notification of requesting a zoom to the digital camera 100. The server 300 sends the enlarged video to the smart phone 250. As described above, processing corresponding to the remote control for the digital camera 100 may be performed in the server 300.

In the above described embodiment, the operation of the digital camera 100A is described by taking the case where the remote control is performed from the smart phone 250 as an example. Also, the digital camera 100B can be controlled via a remote control from the smart phone 250.

Further, in the above described embodiment, the case where the remote control is performed from one smart phone 250 is described. However, the remote control may be performed from a plurality of smart phones. In that case, the server 300 manages notification commands from the smart phones 250, for example. When the server 300 receives a notification command from one smart phone, the server 300 may exclusively perform the processing not to receive notification commands from the other smart phone(s). Alternatively, the digital camera 100A may perform sequential processing on a plurality of commands in the order in which they are received instead of performing exclusive processing by the server 300. As a result, the remote control for the digital camera from the smart phone is enabled also in the case where a plurality of smart phones are connected as in the case where one smart phone is connected.

Although the encoding process (S554) is performed again after the decoding process (S551) is performed in the processes of FIGS. 7A and 7B, the streaming video data may be transcoded without being subject to the decoding process (i.e., as in the original form).

As described above, the embodiments is described as an example of the arts of the present disclosure. For that purpose, the accompanying drawings and the detailed description is provided.

Therefore, the components illustrated and described in the accompanying drawings and the detailed description may include not only the components necessary to solve the problem but also the components unnecessary to solve the problem in order to exemplify the arts. Accordingly, it should not be instantly understood that the unnecessary components is necessary only because the unnecessary components are illustrated or described in the accompanying drawings or the detailed description.

Also, since the above described embodiments are for exemplifying the arts according to the present disclosure, various modifications, substitutions, additions, omissions, and the like may be performed on the embodiments without departing from the scope of the claims and the equivalent of the claims.

### INDUSTRIAL APPLICABILITY

The present disclosure can be applied to a communication system which communicates video data between devices and a relaying device which relays the video data communicated between the devices.

What is claimed is:

1. A communication system comprising at least one sending device, at least one receiving device, and a relaying device for relaying data sent from the sending device to the receiving device, wherein
the relaying device comprises:
a first receiving unit configured to receive at least one streaming video data from the at least one sending device;
a second receiving unit configured to receive, from one of the at least one receiving device, information about a screen configuration of the one receiving device and information for designating streaming video data to be sent to the one receiving device;
a converting unit configured to dynamically convert at least the one designated streaming video data among a plurality of pieces of streaming video data being received from a plurality of sending devices, into streaming video data with lower data volume so that the at least one designated streaming video data fits in the received screen configuration of the one receiving device; and
a sending unit configured to send the converted streaming video data to the one receiving device.

2. The communication system according to claim 1, wherein the converting unit dynamically changes processing of the conversion of the streaming video data according to a state of sending the streaming video data.

3. The communication system according to claim 1, wherein the converting unit performs the conversion to contain the plurality of pieces of streaming video data in one piece of a video streaming data.

4. The communication system according to claim 1, wherein the one receiving device performs a remote control on the sending device via the relaying device with respect to the processing on the streaming video data.

5. The communication system according to claim 4, wherein the relaying device receives information about an operation by a user on the one receiving device from the one receiving device, analyzes the information, and controls based on the analysis result, a status of the streaming video data received from the sending device.

6. The communication system according to claim 4, wherein the relaying device receives information about an operation by a user on the one receiving device from the one receiving device, and sends an instruction about processing of the streaming video data based on the received information about the operation to the sending device.

7. A communication method for a communication system which comprises at least one sending device, at least one receiving device, and a relaying device for relaying data sent from the sending device to the receiving device, comprising:
receiving at least one streaming video data from the at least one sending device;
receiving, from one of the at least one receiving device, information about a screen configuration of the one receiving device and information for designating a streaming video data to be sent to the one receiving device;
dynamically converting at least the one designated streaming video data among a plurality of pieces of streaming video data being received from a plurality of sending devices, into streaming video data with lower data volume so that the at least one designated streaming video data fits in the received screen configuration of the one receiving device; and
sending the converted streaming video data to the one receiving device.

8. A relaying device for relaying data sent from at least one sending device, to at least one receiving device, comprising:
a first receiving unit configured to receive at least one streaming video data from the at least one sending device;
a second receiving unit configured to receive, from one of the at least one receiving device, information about a screen configuration of the one receiving device and information for designating a streaming video data to be sent to the one receiving device;
a converting unit configured to dynamically convert at least the one designated streaming video data among a plurality of pieces of streaming video data being received from a plurality of sending devices, into streaming video data with lower data volume so that the at least one designated streaming video data fits in the received screen configuration of the one receiving device; and
a sending unit configured to send the converted streaming video data to the one receiving device.
